(19) United States
(12) Patent Application Publication
(10) Pub. No.: US 2007/0091382 A1
(43) Pub. Date: Apr. 26, 2007

(54) Scanner/copier based on organic materials

(76) Inventors: Christoph Brabec, Linz (AT); Ralph Patzold, Roth (DE); Carsten Tschamber, Erlangen (DE)

Correspondence Address: YOUNG & THOMPSON, 745 SOUTH 23RD STREET, 2ND FLOOR, ARLINGTON, VA, 22202, US

(21) Appl. No.: 10/578,075

(22) PCT Filed: Nov. 3, 2004
(86) PCT No.: PCT/EP04/52771

§ 371 Date: Jun. 21, 2006

(30) Foreign Application Priority Data
Nov. 5, 2003 (DE) 10351700.6

(51) Int. Cl. H04N 1/04

(52) U.S. Cl. 358/474; 358/509

(57) ABSTRACT

A device (2) for scanning or copying a document and for storing a scanned image or image to be copied, includes a document support (4), a reader (6) and a storage device (8). The storage device (8) includes bi-stable components. The bi-stable components consist of several alternating layers of organic material and electrodes.

The present invention relates to a device for scanning or copying a document. It refers in particular to a device with which each point of a document may be scanned simultaneously, i.e. the document scanning process takes place in parallel instead of in series. The invention further relates to a device that contains a display device, which enables the scanned document image to be displayed by the device itself.

Conventional scanners and copiers normally operate with CCD lines as being the active optical element. The documents are usually illuminated line by line by a dichroic lamp and the reflected light is routed to a sensor via an optical system. This optical system normally consists of at least two mobile deflector mirrors and a lens, by which means the light reflected from the document, even though further reduced, may be focused onto the integrated CCD sensor, which may be fixed or movable. One of the reasons for this is to ensure that the route taken by the light through the movable mirror to the sensor is of equal length at every point in the document.

This conventional scanner construction has various disadvantages. The system requires a fairly large number of optical modules (mirrors, lenses, dichroic lamps, CCDs) and costly mechanics for ensuring the precise movement of the optical system. This construction takes up a large amount of space in the device and the complicated mechanics are expensive to produce. Furthermore, they are liable to wear and may become misaligned, which may cause the picture quality to deteriorate over the lifetime of the device. The reduction of the document image likewise impairs the theoretically possible picture quality during the subsequent necessary enlargement. Furthermore, because of the movable mechanics of the scanner, the scanning process lasts a certain time depending on the speed with which the mirrors and lamps are necessarily moved over the document; quite apart from the potentially disagreeable background noise emanating from the device during operation.

So-called LED scanners represent a further development. In these devices a reading line made of light-emitting diodes and CMOS sensors is used instead of the CCD line and dichroic lamp. This eliminates the need for complex reflector mechanics. Furthermore, no lenses are required since the LED lines mainly extend across the entire width of-the document support. Such reading lines may have a very compact construction and may contain all the electronics necessary for image capture. In this type of scanner the only task of the mechanics is to move the reading line device over the document. The advantages of this type of scanner are the relatively low production costs of the reading lines using economical semiconductor components, the comparatively simple mechanics and the very flat construction that is possible. Furthermore, the potential for mechanical wear is greatly reduced, and the lens does not become misaligned since all the elements necessary for this purpose are integrated in the compact reading line.

However, all of the above-mentioned types of scanner have various disadvantages. They all scan documents serially, i.e. line by line. A scanning operation therefore takes a certain amount of time depending on the operating speed of the mechanics for passing over the document. The mechanical system necessary in each case is potentially noisy, expensive and costly to produce. It takes up a certain amount of space even in extremely compact LED scanners and is always liable to wear and consequently to an accompanying deterioration in picture quality.

Furthermore, the scanned in image can only be viewed with additional equipment. In the case of a scanner, this usually means that a computer is required. This can cause further problems. Firstly, the data connection between computers and scanners (USB, SCSI, parallel interface, etc.) is not standardized. This means that not every scanner can simply be used with every computer. Secondly, a scanner requires the correct driver software and appropriate image processing software, without which the scanned image simply cannot be viewed at all.

One object of the invention, therefore, is to provide a scanner/copier that can be produced as economically as possible, does not have any costly mechanics and enables a document to be read in rapidly. It must also be possible for the image that has been read in to be displayed on the device itself as soon as it is scanned without the need for additional equipment to be used. Other intended features are a light, highly compact construction and low power consumption.

The present invention is based on the idea of providing a device for scanning or copying, having a reader and a storage device made from organic semiconductor components. These organic components (OBDs, OLEDs, photodiodes, and the like.) can be produced inexpensively and are lightweight, energy saving and extremely compact. The storage device is capable of storing the scanned in image. To avoid the need for a mechanical system, the reader extends over the entire document support (i.e. width and length), making it possible for each point of the document to be scanned simultaneously. The device therefore reads in in parallel, whereas conventional scanners read in serially. Furthermore, a display device is provided that enables the document image stored in the storage device to be displayed directly on the scanner/copier itself without additional equipment.

The effects of organic electronics have multiplied in recent years. They permit the manufacture of lighter, more space-saving and cheaper electronic components on the basis of organic materials such as “small molecules” and polymers. A further fundamental advantage consists in the ability to apply organic components to flexible carrier materials. Until now, the pinnacle of this development has been organic light diodes (OLEDs) and organic displays, as well as organic solar cells and photodetectors. The latter essentially consist of thin organic films, which are laid between two electrodes. If light passes through the transparent electrodes, free charge carriers are produced in the organic layer. A voltage between the electrodes can then be picked up via a resistor.

Bistable organic components, known as “organic bistable devices” (OBDs), are components comprising several alternating layers of metal and organic molecules, the conductivity of which can be switched to and fro between two discrete statuses by applying a voltage. In the basic state, without voltage being applied, the resistance of the OBDs is considerable. However, if the contact voltage exceeds a certain level, the conductivity increases by four to five times. This status also continues even after the voltage is switched off. The process may be reversed, however. By briefly applying a low countervoltage, the component can be switched back to the basic state.

If these bistable organic components are combined with the above-mentioned organic light-emitting diodes and the corresponding photodetectors, new types of scanner/copier can be produced with features that have not previously been possible.

According to one aspect of the invention, a device is provided that is intended for scanning or copying a document. The device has a document support upon which a document may be placed for the purpose of scanning. The device also has a reader, which is intended for scanning the document. It also has a storage device, which is constructed from bistable organic components and which stores the scanned document image. The bistable organic components have alternating layers of organic material and electrodes, which - for example - are constructed from metal or an organic conductive material.

It is preferable for the reader to be constructed from organic photodiodes. The light-sensitive photodiodes are used for optically scanning the document. Organic photodiodes are basically constructed from an organic film between two electrode layers.

It is preferable for the reader to contain a document illumination device, which is constructed from organic light diodes. Said document illumination device illuminates the document such that the reader can capture the light reflected by the document. Organic light diodes are basically constructed from an organic film between the electrode layers.

It is preferable for the reader to extend over the entire surface of the document support, i.e. over the entire length as well as over the entire width. This means that each element, i.e. each photodiode of the reader, is assigned to a point of the corresponding size on the document support. The purpose of this is to enable every point of the document to be scanned simultaneously. In other words, this occurs to enable scanning to be carried out in parallel, in contrast to serial scanning in which all points of the document are scanned one after the other.

It is preferable for the storage device to be positioned in alignment with the reader. For this purpose, each photodiode of the reader is assigned a bistable organic component of the storage device. The main effect of this, however, is that the storage device matches the reader in both shape and size. It also means that the storage device is positioned essentially coplanar to the reader.

It is preferable for the device to incorporate a display device constructed from organic light-emitting diodes. The display device is used for enabling the scanned image to be viewed.

It is preferable for the display device to be positioned in alignment with the storage device. For this purpose, each bistable component (OBD) of the storage device is assigned an organic light-emitting diode (OLED) of the display device. The main effect of this, however, is that the display device matches the storage device in both shape and size. It also means that the display device is positioned essentially coplanar to the storage device.

It is preferable for the document support to consist of a touchpad.

Other advantages, features and possible applications of the present invention are explained in the following description of a preferred exemplary embodiment together with the diagram.

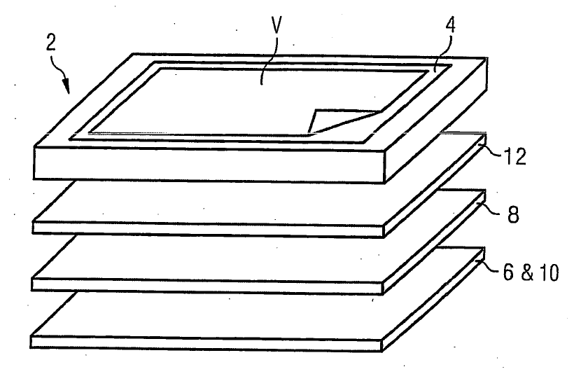

FIG. 1 shows an exemplary form of the device 2 according to the invention.

FIG. 1 shows the gaps between the three layers which relate respectively to a reader 6, to a storage device 8 and to a display device 12. To improve clarity, the gaps are not drawn to-scale. Furthermore, the necessary connections from the reader 6 to the storage device 8 and from the storage device 8 to the display device 12 are not shown. A document V is illustrated as being placed on a document support 4. The layer of photodiodes that forms the reader 6 also contains the organic light-emitting diodes, which form a document illumination device 10.

In operating mode the document to be scanned is first illuminated by the OLEDS integrated in the reader 6. The reflected light falls on the photodetectors in the reader 6 and generates a voltage therein. With this voltage, the OBDs in the storage device 8 are switched from their high impedance status to one with lower resistance depending on the brightness of the captured light. Since the entire document is captured at once when the image data is read in, the time required for scanning using this parallel architecture is reduced to a fraction compared to the times needed using conventional technologies. The image of the document is held in the organic components of the storage device 8. By applying a low voltage to the OBDs and the OLEDS of the display device 12, the stored image can now be displayed directly with the device 2. This means that each OLED in the display device 12 is controlled according to the status of the assigned bistable storage cells. The display device 12 thereby displays the image that is stored in the storage device 8. The described operating mode enables documents to be scanned and copied in grayscale. A grayscale subdivision can be implemented by scaling the capacity of the photodetectors in the reader 6 (e.g. through different layer thickness). Persons skilled in the art should be able to see clearly how the invention may also be implemented for scanning and displaying documents in color using known methods.

The combination of bistable cells with organic photodetectors and organic light-emitting diodes permit the construction of document scanners and copiers which, because of their very low weight, low power consumption and compact dimensions, can be carried to and used virtually anywhere. Such a device is constructed in three layers. The bottom layer (the reader 6) consists of organic photodiodes and possibly an integrated document illumination device 12 (OLEDs). This is followed in the center by the storage device 8 comprising bistable organic cells. The stored information is displayed graphically by a further layer comprising organic light-emitting diodes, which form the display device 12. The layers are constructed in pixilated form, with each photodiode in the reader 6 being assigned a bistable organic component of the storage device 8 and an organic light-emitting diode of the display device 12. The main advantage of this construction is that it enables the stored data to be displayed locally directly on the device, in order—for example—to enable the scanning quality to be assessed immediately. No further equipment—e.g. computer—is required for this purpose, which means that no software of any kind is needed. Another main advantage of the device is that it operates almost completely noiselessly owing to the absence of any mechanical components.

The layer-type arrangement of reader 6 (with integrated document illumination device 12), storage device 8 and display device 12 enables the three devices to be produced cost-effectively and easily in one unit. The necessary connections are thus kept as short as possible. The reader is connected to the storage device to which it can transfer the scanned image. The storage device is connected to the display device to which it can send the stored image. By means of this arrangement, virtually all the technology for a scanner/copier can be produced together in one unit. This makes for cost-effective and extremely compact devices that have a very low energy consumption. Using flexible carrier materials for the organic semiconductor layers, it would also be possible in principle to produce a device that can be rolled up in order to save space.

An extension of the present invention could be implemented, for which purpose the document support 4 would have to be replaced by a transparent touchpad. It would also need to be possible to manipulate the stored image using the touchpad. The image shown by the display device can then be corrected in this way, i.e. dog eared and cut-off corners, dirt particles and coffee stains and the like, copied with the document could be erased, or handwritten comments could be added to the image.

1. Device (2) for scanning or copying a document and for storing a scanned image or image to be copied, comprising a document support (4), a reader (6) and a storage device (8), characterized in that said storage device (8) has bistable components, said bistable components consisting of several alternating layers of organic material and electrodes.

2. Device according to claim 1, whereby the reader (6) has photodetectors, said photodetectors consisting at least of a layer of organic materials between two electrode layers.

3. Device according to claim 1, whereby the reader (6) has a document illumination device (10), said illumination device (10) having light-emitting diodes, said light-emitting diodes consisting at least of a layer of organic materials between two electrode layers.

4. Device according to claim 1, whereby the reader (6) is positioned in alignment with the document support (4) and essentially coplanar to the document support (4).

5. Device according to claim 1, whereby the storage device (8) is positioned in alignment with the reader (6) and essentially coplanar to the reader (6).

6. Device according to claim 1, comprising a display device (12) which has light-emitting diodes, said light-emitting diodes consisting at least of a layer of organic materials between two electrode layers.

7. Device according to claim 1, whereby the display device (12) is positioned in alignment with the storage device (8) and essentially coplanar to the storage device (8).

8. Device according to claim 1, whereby the document support (4) has a touchpad.
